(19) United States
(12) Patent Application Publication
(10) Pub. No.: US 2013/0035439 A1
(43) Pub. Date: Feb. 7, 2013

(54) METHOD FOR PRODUCING PAVEMENTS FOR OUTDOOR FACILITIES, THE SURFACE FINISHING MATERIAL USED THEREIN, AND THE PAVEMENTS FOR OUTDOOR FACILITIES OBTAINED THEREBY

(71) Applicants: Mutsuko Doro, Hyogo (JP); Tadayoshi Mikami, Kobe (JP); Akira Hikata, Hyogo (JP)

(72) Inventors: Mutsuko Doro, Hyogo (JP); Tadayoshi Mikami, Kobe (JP); Akira Hikata, Hyogo (JP)

(73) Assignee: BAYER INTELLECTUAL PROPERTY GMBH, MONHEIM (DE)

(21) Appl. No.: 13/516,042

(22) PCT Filed: Dec. 9, 2010
(86) PCT No.: PCT/EP10/69314

§ 371 Date: Aug. 2, 2012

(30) Foreign Application Priority Data
Dec. 15, 2009 (JP) 2009-284251

(51) Int. Cl. C09D 175/04; B05D 7/24

(52) U.S. Cl. 524/590; 427/136

(57) ABSTRACT

The present invention concerns a method for producing pavements for outdoor facilities, the surface finishing material used therein, and the pavements for outdoor facilities obtained thereby.

The present invention concerns a method for producing pavements for outdoor facilities, the surface finishing material used therein, and the pavements for outdoor facilities obtained thereby.

The surfaces of pavements of outdoor facilities such as all-weather athletics tracks, multipurpose playgrounds, park and recreation trails etc. are often finished by forming a roughened surface layer on the surface of an elastic pavement base-layer using various types of surface finishing material in order to meet the requirements that (1) a good appearance is maintained over a long period of time, (2) the characteristics necessary for realizing the functions required of the surface are provided, and (3) the safety of the users of these facilities is ensured.

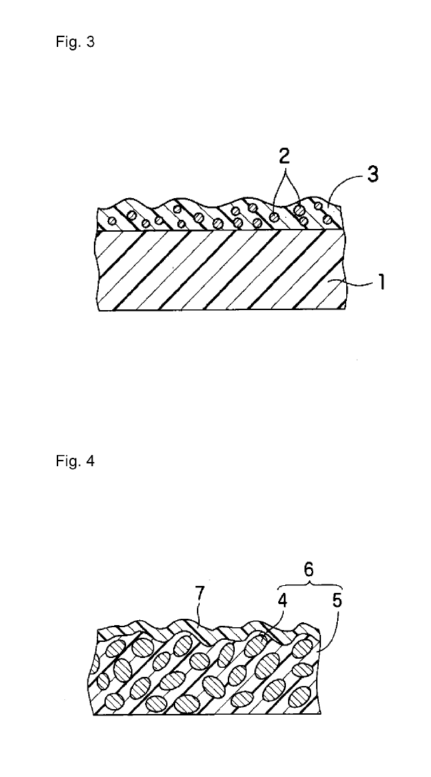

For example, the method in which a two-liquid curable polyurethane resin composition 3 which contains polyurethane foam particles 2 is sprayed onto the flat surface of a polyurethane pavement elastomer 1 to form a rough coating, as shown in FIG. 3, is known as such a method of finishing a pavement (JP 57-55846).

Furthermore, a method in which an elastic mat 6 wherein elastic chips 4 comprised of vulcanized rubber, urethane elastomer or the like have been bonded with a urethane binder 5 is used as a base-layer and a surface layer 7 of rapid-curing type urethane elastomer which does not contain elastic chips is formed on the rough surface as shown in FIG. 4 (JP 63-304804), and an elastic pavement where a material in which chips of soft foam are included in a specified foamed polyurethane resin is coated on a foundation as a under-layer and a non-foamed polyurethane material is laminated thereon (JP 11-81210), have been proposed as methods in which it is not the surface layer which provides the roughened finish.

However, with the method for obtaining a rough surface finish by spraying a polyurethane composition containing elastic particles (chips) through a spray nozzle or the like in the way described in the above mentioned Patent document 1 it is not easy to distribute the elastic particles uniformly over the sprayed surface and there is a further problem that it is not easy to obtain a surface roughness which has the intended depth. Further, the elastic particles which account for the roughness for may be shed with the passage of time and there is a further problem with the durability.

On the other hand, when a surface layer is to be formed over on the top without losing the roughness of the under-layer surface as described in the above mentioned Patent documents 2 and 3 a surface layer finishing material which has excellent fluidity and a viscosity such that it does not to run into the bottom of the troughs of the roughness is required and control is difficult and there is a problem in that the depth of the roughness ultimately obtained will be reduced.

Moreover in the past tolylene di-isocyanate (hereinafter referred to as TDI) has been used generally for the urethane pre-polymer component in many of the surface finishing materials in which polyurethane compositions are used, but TDI has a higher saturated vapour pressure in air at normal temperature than diphenylmethane di-isocyanate (hereinafter referred to as MDI) and there is a higher probability that the vapour will be inhaled during the spaying operation. Consequently the use of MDI instead of TDI has been investigated in consideration of health and safety in the working environment and operator safety, but MDI reacts more quickly with the polyol component than TDI and the reaction is much more difficult to the control and so there is a problem in that a rough surface cannot be formed evenly by spraying a liquid mixture of the A and B components from a spray nozzle or the like.

Furthermore, the 3,3′-dichloro-4,4′-diaminodiphenylmethane (hereinafter referred to as MOCA) which has been used conventionally as a good crosslinking agent for polyurethane compositions may be carcinogenic in humans and so various new paving methods in which MOCA is not used have been investigated.

The present invention is based upon an understanding of the situation outlined above and is intended to provide a method for producing pavements for outdoor facilities with which a pavement surface which has excellent physical properties can be produced safely without using the above mentioned TDI or MOCA, surface finishing material which can be used in this method and pavements for outdoor facilities which have been obtained with this method.

In order to realize the above mentioned aims a first embodiment of the present invention is a method for producing pavements for outdoor facilities in which a polyurethane surface finishing layer which has a surface roughness of peak-trough depth at least 2.0 mm is formed by spraying the A and B components indicated below, which have been metered separately, in a mixed state onto a polyurethane base-layer of JIS A-hardness from 40 to 65 which has a flat surface.

The A Component: A composition which has a urethane pre-polymer which has terminal isocyanate groups, obtained by reacting MDI and polyol, as the main component which does not contain elastic chips and which has been prepared with a viscosity at 30° C. of from 1,000 to 10,000 mPa·s (BH type No. 7 rotor, 20 rpm).

The B Component: A composition which has polyol as the main component, which contains crosslinking agent, filler, catalyst and an inorganic thixotropic agent, which does not contain elastic chips and which has been prepared with a viscosity at 30° C. of from 70,000 to 200,000 mPa·s (BH type No. 7 rotor, 20 rpm).

A second embodiment of the present invention is a method for producing pavements for outdoor facilities in which, in the above mentioned method, components which have reactivities such that the pot life of the mixed liquid obtained on mixing the two liquids is from 5 to 20 seconds and the tack-free time is not more than 150 seconds are used for the A and B components.

Furthermore, a third embodiment of the present invention is a method for producing pavements for outdoor facilities in which, in the above mentioned methods, the urethane pre-polymer used in the above mentioned A component is a pre-polymer which has terminal isocyanate groups, obtained by reacting MDI with a polyether polyol, of which the average number of functional hydroxyl groups is from 2 to 4, the average molecular weight is 2,000 to 8,000 and in which the polyoxyethylene chain content of the polyether chain is not more than 30 wt %, and of which the NCO content is within the range from 3 to 10 wt %, and a fourth embodiment of the present invention is a method for producing pavements for outdoor facilities in which the polyol used in the above mentioned B component is a polyether polyol of which the average number of functional hydroxyl groups is from 2 to 4, the OH value is from 20 to 100 mg KOH/g and the average molecular weight is from 2,000 to 8,000, and in which the polyoxyethylene chain content of the polyether chain is not more than 30 wt %.

Moreover, a fifth embodiment of the present invention is a method for producing pavements for outdoor facilities in which, in the above mentioned methods, the crosslinking agent used in the above mentioned B component is an aromatic amine based crosslinking agent, a sixth embodiment of the present invention is a method for producing pavements for outdoor facilities in which, in the above mentioned methods, the above mentioned polyurethane base-layer is a layer obtained by the reaction of MDI and polyol, and a seventh embodiment of the present invention is a method for producing pavements for outdoor facilities in which, in the above mentioned methods, the A component contains from 0.1 to 2.6 wt % of an organic thixotropic agent.

Moreover, an eighth embodiment of the present invention is a surface finishing material which can be used in the method for producing pavements for outdoor facilities of the first invention described above which is comprised of the A and B components indicated below.

The A Component: A composition which has a urethane pre-polymer which has terminal isocyanate groups, obtained by reacting MDI and polyol, as the main component which does not contain elastic chips and which has been prepared with a viscosity at 30° C. of from 1,000 to 10,000 mPa·s (BH type No. 7 rotor, 20 rpm).

The B Component: A composition which has polyol as the main component, which contains crosslinking agent, filler, catalyst and an inorganic thixotropic agent, which does not contain elastic chips and which has been prepared with a viscosity at 30° C. of from 70,000 to 200,000 mPa·s (BH type No. 7 rotor, 20 rpm).

Furthermore, a ninth embodiment of the present invention is a surface finishing material in which, in the above mentioned surface finishing material, the A and B components have a reactivity such that the pot life of the mixed liquid obtained on mixing the two liquids is from 5 to 20 seconds and the tack-free time is not more than 150 seconds.

Moreover, a tenth embodiment of the present invention is a surface finishing material in which, in the above mentioned surface finishing material, the urethane pre-polymer used in the above mentioned A component is a pre-polymer which has terminal isocyanate groups, obtained by reacting MDI with a polyether polyol of which the average number of functional hydroxyl groups is from 2 to 4, the average molecular weight is 2,000 to 8,000 and in which the polyoxyethylene chain content of the polyether chain is not more than 30 wt %, and of which the NCO content is within the range from 3 to 10 wt %, and an eleventh embodiment of the present invention is a surface finishing material in which the polyol used in the above mentioned B component is a polyether polyol of which the average number of functional hydroxyl groups is from 2 to 4, the OH value is from 20 to 100 mg KOH/g and the average molecular weight is from 2,000 to 8,000 and in which the polyoxyethylene chain content of the polyether chain is not more than 30 wt %.

Further, a twelfth embodiment of the present invention is a surface finishing material in which, in the above mentioned materials, the crosslinking agent used in the above mentioned B component is an aromatic amine based crosslinking agent, and a thirteenth embodiment of the present invention is a finishing material in which the A component contains from 0.1 to 2.6 wt % of an organic thixotropic agent.

A fourteenth embodiment of the present invention is a pavement for outdoor facilities which has been obtained by a method of production outlined in any one of the first to the seventh embodiments of the invention where a polyurethane surface finishing layer of elongation at break at least 500% which has a surface roughness of peak-trough depth at least 2.0 mm and which does not contain elastic chips has been formed on a base-layer comprising cured polyurethane of JIS A-hardness from 40 to 65 which has a flat surface.

Moreover a fifteenth embodiment of the present invention is a pavement for outdoor facilities, from among the above mentioned pavements for outdoor facilities, of which the physical properties of the pavement are a displacement of from 0.6 to 2.2 mm and an impact absorption rate of from 34 to 51% which can be used as the pavement for an athletics track.

That is to say, the method for producing a pavement for outdoor facilities of the present invention is a method in which a polyurethane surface finishing layer (hereinafter referred to simply as the surface finishing layer) which has a rough surface with a large peak-trough depth of 2.0 mm or more is obtained by separately metering out a urethane pre-polymer composition (A component) which has MDI as the main component and a viscosity set within a specified range and a polyol composition (B component) which has a viscosity set within a specified range and spraying them in a mixed state using a two-liquid type spraying machine. With this method there is no need to form roughness at the surface of the base-layer and form a surface finish layer which follows the roughened form thereon, or to form a surface finish layer wherein roughness is provided by means of elastic chips as was the case in the past as it is possible to form roughness with a peak-trough depth on a flat base surface both uniformly and quickly, and the operability is very good. Furthermore, since MDI is used as the main component of the A component rather than TDI, safety can be ensured for the workers and in the surrounding environment. Furthermore, the resulting polyurethane surface finishing layer does not contain elastic chips and so there is no problem with shedding of elastic chips as a result of the adhesion between elastic chips and the polyurethane resin declining in the long term and so the durability is very good.

Furthermore when, in the method of production of the present invention, components having such reactivity that the pot life of a mixed liquid obtained by mixing the two liquids is from 5 to 20 seconds and the tack-free time is not more than 150 seconds are used for the A and B components, the reactivity of the two liquids is very high and, moreover, good control can be achieved and a rough surface finishing layer can be formed in a very short time and this is ideal. Furthermore, the reaction proceeds rapidly and the physical properties of the resin are also realized very quickly and so subsequent operations can take place immediately and there is an advantage in that the overall working time can be shortened.

Moreover, in the method of production of the present invention the urethane pre-polymer which is used in the above mentioned A component is preferably a pre-polymer which has terminal isocyanate groups, which has been obtained by reacting MDI and a polyether polyol of which the average number of functional hydroxyl groups is from 2 to 4, the average molecular weight is from 2,000 to 8,000 and in which the polyoxyethylene chain content of polyether chain is not more than 30 wt %, of which the NCO content is within the range from 3 to 10 wt %, and the polyol used in the above mentioned B component is preferably a polyol of which the average number of functional hydroxyl groups is from 2 to 4, the OH value is from 20 to 100 mg KOH/g and the average molecular weight is 2,000 to 8,000 and in which the polyoxyethylene chain content of the polyether chain is not more than 30 wt %.

When, in the method of production of the present invention, the crosslinking agent used in the above mentioned B component is an aromatic amine based crosslinking agent, and more desirably diethyltoluenediamine (hereinafter referred to as DETDA) in particular, no MOCA which has associated safety problems is used and the operation can proceed safely and with good efficiency.

Furthermore, in the method of production of the present invention the polyurethane base layer which forms the under-layer is preferably a layer which has been obtained by reacting MDI and polyol, the components being in common with those of surface finishing layer. Moreover, if the above mentioned A component includes from 0.1 to 2.6 wt % of an organic thixotropic agent then it is possible to obtain a surface finishing layer where the roughness is more evenly distributed and which has excellent physical properties.

Moreover, the above mentioned method for producing pavements for outdoor facilities of the present invention can be carried out efficiently with a surface finishing material of the present invention.

A pavement for outdoor facilities of the present invention has a surface finishing layer which has a roughness with a peak-trough depth of at least 2.0 mm and excellent physical properties as an elastic pavement so that people walking and taking part in sports on the pavement can do so safely.

Furthermore, with a pavement for outdoor facilities of the present invention the properties of the pavement include in particular a displacement of from 0.6 to 2.2 mm and an impact absorption of from 34 to 51% and a pavement which is to be used as the pavement of an athletics track is of excellent quality which satisfies the specification set by the International Association of Athletic Federations (IAAF specification) and so can be used for high-standard sporting events such as international athletics competitions.

FIG. 1 is an explanatory drawing of a method of production which is an embodiment of the present invention showing a polyurethane base layer 10.

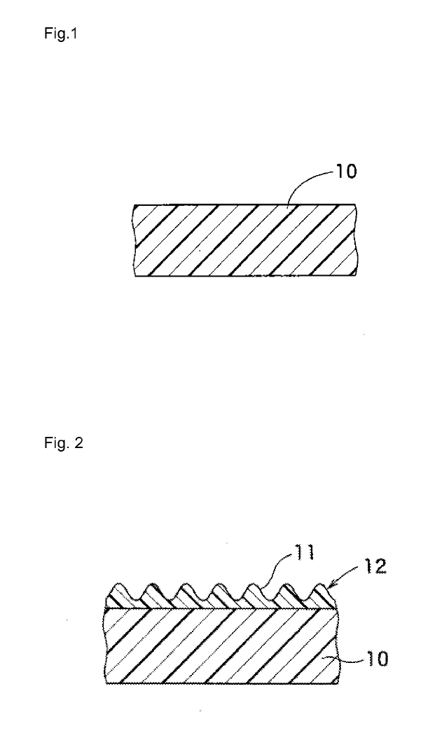

FIG. 2 is an explanatory drawing of a method of production which is an embodiment of the present invention showing a surface finish layer 12 comprising a polyurethane base layer 10 and a rough surface 11.

FIG. 3 is an explanatory drawing which shows an example of the surface finish structure of a conventional elastic pavement material.

FIG. 4 is an explanatory drawing which shows another example of the surface finish structure of a conventional elastic pavement material.

Preferred embodiments of the invention are described below.

First of all the surface finishing material used in the present invention comprises a polyurethane composition in which an A component which has a urethane pre-polymer which has terminal isocyanate groups, obtained by reacting polyisocyanate and polyol, as the main component and a B component which has polyol as the main component and which includes crosslinking agent, filler, catalyst and inorganic thixotropic agent are combined.

MDI in various forms can be used as the isocyanate of the urethane pre-polymer which is the main component of the above mentioned A component. From among these forms a monomeric MDI is preferred. As well as 4,4′-MDI, 2,4′-MDI and 2,2′-MDI are also included among these monomeric MDI forms. However, when large amounts of these isomers are used there is a risk that the reactivity will fall and the physical properties will be adversely affected and so when they are used they are preferably used in a proportion of not more than 70 wt % of the monomeric MDI. Moreover, the procurement of monomeric MDI which includes 70 wt % or more of 2,4′-MDI and 2,2′-MDI is also undesirable in economic terms.

The above mentioned monomeric MDI may be used alone, or it can be used in combination with polymeric MDI which is an oligomer of MDI or with a modified monomeric MDI. However, the use of these may result in the urethane pre-polymer having a very high viscosity and there is a further problem in that the physical properties, and especially the elongation at break, will be adversely affected and so when these are used they are preferably used in a proportion of not more than 50 wt % with respect to the monomeric MDI.

Furthermore, a polyether polyol, polyoxytetramethylene glycol, polycaprolactam polyol, polyester polyol or the like can be cited as polyols which can be used together with the above mentioned polyisocyanates for a urethane pre-polymer which can be used in the present invention, and from among these the polyoxyalkylene polyols obtained by the addition polymerization of propylene oxide, ethylene oxide or the like with polyhydric alcohols such as ethylene glycol, propylene glycol, 1,4-butanediol, glycerine, trimethylolpropane, pentaerythritol and the like can be used ideally. From among these the polyether polyols which have an average number of functional hydroxyl groups of from 2 to 4, an average molecular weight of from 2,000 to 8,000 and in which the polyoxyethylene chain content of the polyether chain is not more than 30 wt % are ideal.

That is to say, curing of the polyurethane is markedly impeded when the average number of functional hydroxyl groups is less than 2, the OH value is less than 20 mg KOH/g or the average molecular weight is more than 8,000, and the hardness of cured polyurethane becomes too high when the average number of functional hydroxyl groups exceeds 4, the OH value exceeds 100 mg KOH/g, or the average molecular weight is less than 2,000, and this undesirable. Furthermore, if the polyoxyethylene chain content of the polyether chain is more than 30 wt % then defects such as voids caused by water and sticking are liable to occur when spraying, and this is undesirable.

The urethane pre-polymers which can be used in the present invention can be obtained using the above mentioned polyisocyanates and polyols in the following way for example. That is to say, first of all the above mentioned polyisocyanate is mixed with the polyol in a proportion which is in excess with respect to the polyol. The target urethane prepolymer can then be obtained by stirring at a prescribed temperature (for example from 50 to 120° C.).

The isocyanate content in the above mentioned urethane pre-polymer (hereinafter referred to as the NCO %) is set within the range from 3.0 to 10.0 wt %, and preferably within this range from 4.0 to 6.0 wt %. That is to say, if the NCO % is too low then the viscosity of urethane pre-polymer rises and mixing with the B component becomes difficult. Furthermore there is also a risk that the resulting surface finishing layer will remain tacky. On the other hand, if the NCO % is too high then the reaction proceeds rapidly and the time for which the surface remains tacky is short but there is a risk that the reaction will be too rapid and the spraying operation will be difficult. Furthermore, if the NCO % is either too high or too low the balance of the mixing proportions of the A and B components become poor and there is a high risk that mixing failure will be a problem.

An inorganic thixotropic agent or organic thixotropic agent can be compounded, as required, together with the above mentioned urethane pre-polymer in the A component which is used in the present invention. The inorganic thixotropic agent or organic thixotropic agent has the effect of enhancing the thixotropic properties. As a result is possible to obtain a surface finishing layer with a rough surface by spraying the mixed liquid more effectively.

Moreover, the inorganic thixotropic agent or organic thixotropic agent is ordinarily compounded in the B component to which it can be added easily, but the viscosity of the B component is already fairly high and a limit is imposed from the viewpoint of the operation of the spraying machine, and in those cases where there is risk that the rough form of the surface finishing layer will be unsatisfactory as a result of simply controlling the thixotropic properties of the B component, the compounding of an inorganic thixotropic agent or organic thixotropic in the A component can be very effective.

However, the main component of the A component is a urethane pre-polymer with terminal NCO groups and so when an inorganic thixotropic agent is used any adjustment of the viscosity is difficult to achieve, complete elimination of the water which is included in the inorganic thixotropic agent is difficult to achieve (any residual water reacts with urethane prepolymer) and an inorganic thixotropic agent is liable to separate and so in the main the use of an organic thixotropic agent is preferred.

It is important that the above mentioned organic thixotropic agent should have a structure such that reaction with the urethane pre-polymer does not occur, and preferably it is a liquid which does not contain highly reactive active hydrogen such as hydroxyl groups, amino groups or the like. Polyester ether compounds can be cited as examples of such organic thixotropic agents. The amount of the abovementioned organic thixotropic agent compounded is preferably set to from 0.1 to 2.6 wt % with respect to the whole of the A component. If there is too little organic thixotropic agent then the compounding of the organic thixotropic agent has little effect, and if there is too much organic thixotropic agent then no effect beyond than that required is obtained.

In those cases where an inorganic thixotropic agent is used together with the above mentioned organic thixotropic agent it is important that sufficient care should be taken to ensure that no water is introduced into the A component from the inorganic thixotropic agent or in the process of dispersing the inorganic thixotropic agent.

Furthermore, appropriate additives such as plasticizers, antifoaming agents and the like can be compounded, as required, in the above mentioned A component. Di-isononyl phthalate (hereinafter referred to as DINP), di-isononyl adipate (hereinafter referred to as DINA), dioctyl phthalate, dioctyl adipate and the like can be cited as examples of the above mentioned plasticizers. Dimethylsiloxane type antifoaming agents, polyacrylate type antifoaming agents and the like can be cited as examples of the above mentioned antifoaming agents.

The viscosity at 30° C. of an A component comprised of these essential components and optional components must be set to from 1,000 to 10,000 mPa·s, and preferably to from 3,000 to 6,000 mPa·s. This is because if the viscosity is too low then thixotropic properties cannot be realized satisfactorily and this is disadvantageous in terms of the formation of roughness after reaction, and also because if the viscosity is too high then spraying with a spraying machine is liable to be difficult.

Moreover, viscosity in the present invention signifies the value measured using a Brookfield viscometer (BH type) under the conditions of No. 7 rotor, 20 rpm and 30° C.

On the other hand, the polyol used as a main component of the B component in the present invention is preferably a polyether polyol which has an average number of functional hydroxyl groups of from 2 to 4, an OH value of from 20 to 100 mg KOH/g and an average molecular weight of from 2,000 to 8,000 and in which the polyoxyethylene chain content of the polyether chain is not more than 30 wt %. Moreover, the type of polyol used may be the same as or different from the type of polyol used in the urethane prepolymer of the A component.

In those cases where the average number of functional hydroxyl groups of the above mentioned polyol is less than 2, the OH value is less than 20 mg KOH/g and the average molecular weight is less than 2,000 the curing of polyurethane is markedly inhibited, and in those cases where the average number of functional hydroxyl groups exceeds 4, the OH value exceeds 100 mg KOH/g, and the average molecular weight exceeds 8,000 the hardness of the cured polyurethane becomes too high and this is undesirable. Furthermore, if the polyoxyethylene chain content of the polyether chain exceeds 30 wt % then defects such as voids caused by water and sticking tend to occur when spraying and this is undesirable.

Furthermore, DETDA, isobutyl-4-chloro-3,5-diaminobenzoate (ICDAB), dimethylthiotoluenediamine (DMTDA), 1,4-butanediol (1,4-BD) and the like can be cited as crosslinking agents which can be used together with the above mentioned polyol in the above mentioned B component. The use from among these of an aromatic amine based crosslinking agent is desirable for maintaining and improving performance such as strength and elasticity, and the use of DETDA is especially desirable.

Calcium carbonate, barium sulfate, zeolite, talc, anhydrous gypsum (CaSO₄), mica and the like can be cited as fillers which can be used in the above mentioned B component, and these may be used individually or a combination of two or more can be used. The amount of these fillers compounded is preferably set to be not more than 80 wt %, for example from 30 to 70 wt %, with respect to the whole of the B component.

Moreover, lead octylate (OctPb), lead naphthenate, dibutyltin dilaurate, dimethyltin dilaurate and the like can be cited as catalysts which can be used in the above mentioned B component.

Furthermore, the inorganic thixotropic agent which is used in the above mentioned B component acts in such a way as to enhance the thixotropy of the B component and when mixed and sprayed with the aforementioned A component this has the effect of enabling a rough surface finishing layer to be formed more effectively. Fatty acid surface-treated calcium carbonate, carbon black, colloidal silica and the like can be cited as such inorganic thixotropic agents, and these may be used individually or a combination of two or more types can be used. The amount of these inorganic thixotropic agents compounded is preferably set to from 5 to 20 wt % with respect to the whole of the B component. If the amount of inorganic thixotropic agent compounded is too small then there is a risk that the effect of forming a finishing layer with a rough surface will be lacking and if, conversely, the amount of inorganic thixotropic agent compounded is too large then the viscosity of B component becomes too high and this is undesirable.

Moreover, an organic thixotropic agent can be used in combination with the above mentioned inorganic thixotropic agent. In this case, the amount of organic thixotropic agent compounded is preferably set to be not more than 1.5 wt % with respect to the whole of the B component. However, when an organic thixotropic agent is used in the B component it is difficult to adjust the compounding proportions of filler, inorganic thixotropic agent and organic thixotropic agent in such a way that the viscosity of the B component does not to become too high. For these reasons it is desirable that the organic thixotropic agent should be compounded in the A component and the filler and inorganic thixotropic agent should be compounded in B component.

Furthermore, in addition to these essential components, coloring agents, moisture absorbing agents, antifoaming agents, plasticizers, stabilizers, leveling agents, modifiers and the like can be added appropriately, as required, to the above mentioned B component. Ferric oxide, titanium oxide, red iron oxide, chromium oxide and the like can be cited as examples of the above mentioned coloring agents, and zeolites and the like can be cited as examples of the moisture absorbing agents. The same antifoaming agents as used in the A component, such as dimethylsiloxane type antifoaming agents, polyacrylate type antifoaming agents and the like, can be used as antifoaming agents and the same to plasticizers as used in the A component, such as DINP, DINA, dioctyl phthalate, dioctyl adipate and the like can be cited as examples of the above mentioned plasticizers. Moreover, hindered phenols, hindered amines, benzothiazoles and the like can be cited as examples of the above-mentioned stabilizers. These optional components may be the same as the ones used in the A component or they may be different from those used in the A component.

The above mentioned B component can be obtained by suitably mixing from 15 to 30 wt % of polyol, from 2.5 to 5.0 wt % of aromatic amine based crosslinking agent, from 45 to 55 wt % of filler, from 1 to 3 wt % of catalyst, from 10 to 15 wt % of thixotropic agent and from 7 to 15 wt % of additives.

The viscosity at 30° C. of the B component obtained in this way must be set to from 70,000 to 200,000 mPa·s, and preferably to from 90,000 to 150,000 mPa·s. If the viscosity of the B component is too low then satisfactory thixotropic properties cannot be realized and problems arise with the physical properties, and the peak-trough depth of the roughness obtained is liable to be inadequate. On the other hand, if the viscosity is too high then spraying with a spraying machine becomes difficult.

The thixotropy index (hereinafter referred to as the TI value) of the above mentioned B component is preferably set to from 5.0 to 8.0. This is because it is difficult to obtain the intended rough form of the present invention if the TI value is below this range. It is also because spraying with a spraying machine becomes difficult if, conversely, the TI value is above the above mentioned range.

Moreover, the TI value in the present invention is the value obtained using the following formula (1) from the viscosity measured using a Brookfield viscometer (BH type) under the conditions of No. 7 rotor, 20 rpm and 30° C. and the viscosity measured on changing the rotation speed to 2 rpm while keeping the other conditions the same.

TI Value=Viscosity at 2 rpm/Viscosity at 20 rpm (1)

Neither the A component nor the B component contains elastic chips such as polyurethane chips, rubber chips or the like. That is to say, a distinguishing feature of the present invention is that a satisfactory surface finishing layer which has the required surface roughness is obtained in a short period of time by spraying the A and B components which do not contain elastic chips in a mixed state onto the flat surface of a urethane base-layer and curing as the roughness is being established.

In order to form a pavement for outdoor facilities of the present invention the above mentioned A and B components are each metered out in suitable proportions and introduced into a two-liquid type spraying machine and the two components are sprayed in the mixed state onto the flat surface of a polyurethane base-layer 10 as shown in FIG. 1. In this way the target pavement for outdoor facilities is obtained by forming the surface finishing layer 12 which has a rough surface 11 on the polyurethane base layer 10, as shown in FIG. 2.

A surface finishing layer 12 of the pavement for outdoor facilities obtained in this way has an excellent form with a rough surface 11 with a peak-trough depth of 2.0 mm or more since the reactivity of the A and B components is high and the pot life is short and the A and B components have special constitutions so that they are set to appropriate viscosities and curing takes place as roughness is being produced uniformly over the urethane base layer 10 as a result of their being sprayed from a two-liquid spraying machine. The physical properties are very good as a pavement for outdoor facilities with an elongation at break of at least 500%. The above mentioned surface roughness does not include elastic particles such as rubber chips and so even when it is subjected to repeated impact by spikes and the like there is no abrasion due to the detachment of elastic particles and the like, and there is an advantage in that the physical properties of the pavement are maintained over a prolonged period of time.

Moreover, in the above mentioned method for forming pavements for outdoor facilities, the reactivity on mixing the A and B components is ideal for obtaining a surface finishing layer which has a roughness with the required peak-trough depth when the pot life is from 5 to 20 seconds and the tack-free time is not more than 150 seconds and preferably not more than 60 seconds. If the reactivity is higher than this then mechanical problems are liable to arise during spraying and if, conversely, the reactivity is lower than this then it becomes difficult to obtain a surface finishing layer which has roughness with the required peak-trough depth because the shape-holding power of the resin immediately after spraying is weak.

In order to obtain the preferred reactivity the mixing proportions of the A and B components are preferably set in such a way that the equivalent ratio of isocyanate and active hydrogen is from 0.9 to 1.4. That is to say, if the above mentioned equivalent ratio is less than 0.9 then there is a risk that the hardness of the resulting surface finishing layer will fall and the physical properties such as durability will decline and if, conversely, the abovementioned equivalent ratio is more than 1.4 then there is a risk that the elasticity will be reduced and that the tack-free time will become too long.

Furthermore, in the abovementioned method for producing pavements for outdoor facilities the polyurethane base-layer 10 onto which surface finishing material is sprayed should be a layer which has polyurethane of JIS A-hardness from 40 to 65 as the main component. If the hardness is outside this range then it becomes difficult to obtain a pavement which has the desired physical properties even if the surface finishing material is adjusted. Moreover, the abovementioned polyurethane base-layer 10 is not necessarily composed of polyurethane alone and other resin components or rubber components such as ethylene-propylene-diene rubber (EPDM), butadiene rubber and the like may be admixed therein. From the health and safety viewpoint during construction, MDI pre-polymers and non-MOCA type crosslinking agent materials are preferably selected for the polyurethane base-layer when producing a new pavement rather than materials in which TDI pre-polymers and MOCA are used.

Moreover, the two-liquid type spraying machine which is used in the above mentioned method for producing pavements for outdoor facilities is preferably a spraying machine of the type where the A and B components can be introduced separately into the main body of the machine and discharged in the form of a mixture. The machine may be of the high-pressure type or the low-pressure type and it can be selected appropriately in accordance with the air pressure when the liquid mixture of the two components is being discharged and the discharge rate, the liquid properties, the intended thickness of the surface finishing layer 12 and such like factors.

The pavements for outdoor facilities of the present invention obtained in this way are pavements which are installed outside in various types of facility and, in more practical terms, they can be used ideally as pavement finishes, waterproof finishes and the like for artificial surfaces which are provided as athletics tracks, park and recreation trails, jogging paths, multipurpose play grounds, tennis courts and the like.

Moreover, according to the present invention, the pavements for outdoor facilities obtained can be finished in such a way that the amount of displacement is from 0.6 to 2.2 mm and the impact absorption rate is from 34 to 51%. These values satisfy the IAAF specifications and so the pavements can be used for high level sporting events such as international athletics competitions and the like.

### EXAMPLES

Illustrative examples of the invention are described below along with comparative examples. However, the present invention is not limited by these illustrative examples. Moreover, the component compositions indicated below are all given on a by-weight basis.

### Preparation of A Components

A components (A-1 to A-8) which contained a urethane pre-polymer which had terminal isocyanate groups as the main component were prepared by mixing the monomeric MDI (4,4′-MDI content 60%), polyol and other components indicated in Tables 1 and 2 below under a nitrogen atmosphere, reacting the mixture at 80° C. for 20 hours and then cooling.

TABLE 1

| A Component | | A-1 | A-2 | A-3 | A-4 |
|---|---|---|---|---|---|
| Composition | Monomeric MDI | 21.7 | 15.9 | 35.2 | 40.6 |
| (parts) | Polyol 1 *1 | 78.3 | 84.1 | 64.8 | 59.4 |
| | Inorganic | — | — | — | — |
| | thixotropic agent *2 | | | | |
| | Organic thixotropic | 1.8 | 1.8 | 1.8 | 1.8 |
| | agent *3 | | | | |
| Characteristics | NCO % | 5.0 | 3.0 | 10.0 | 12.0 |
| | Viscosity (30 C.°) | 5000 | 8000 | 1500 | 800 |

*1: polyoxypropylene polyol (number of functional groups: 2, Mw = 3000) (same in the following tables)
*2: Calfine 200M produced by the Maruo Calcium Co., Ltd. (same in the following tables)
*3: SBU DS produced by the Sumika Bayer Urethane Co., Ltd (same in the following tables)

TABLE 2

| Material A | | A-5 | A-6 | A-7 | A-8 |
|---|---|---|---|---|---|
| Composition | Monomeric MDI | 21.7 | 21.7 | 21.7 | 21.7 |
| (parts) | Polyol 1 *1 | 78.3 | 78.3 | 78.3 | 78.3 |
| | Inorganic | — | — | — | — |
| | thixotropic | | | | |
| | agent *2 | | | | |
| | Organic | — | 0.1 | 2.6 | 3.4 |
| | thixotropic | | | | |
| | agent *3 | | | | |
| Characteristics | NCO % | 5.0 | 5.0 | 5.0 | 5.0 |
| | Viscosity (30 C.°) | 5000 | 5000 | 5000 | 5000 |

### Preparation of B Components

B components (B-1 to B-7) which contained polyol as a main component were prepared by mixing the polyol and other components indicated in Tables 3 and 4 below using a high-speed rotary stirrer.

TABLE 3

| B Component | | B-1 | B-2 | B-3 | B-4 |
|---|---|---|---|---|---|
| Composition | Polyol 2 *11 | 21.2 | 21.2 | 21.2 | 21.2 |
| (parts) | Crosslinking | 3.4 | 3.4 | 3.4 | 3.4 |
| | agent *12 | | | | |
| | Filler *13 | 49.0 | 49.0 | 49.0 | 49.0 |
| | Catalyst *14 | 1.9 | 1.9 | 1.9 | 1.9 |
| | Inorganic | 13.5 | — | 11.1 | 16.0 |
| | thixotropic | | | | |
| | agent *2 | | | | |
| | Organic | — | — | — | — |
| | thixotropic | | | | |
| | agent *3 | | | | |
| | Weathering | 1.1 | 1.1 | 1.1 | 1.1 |
| | stabilizer | | | | |
| | *15 | | | | |
| | Coloring | 2.5 | 2.5 | 2.5 | 2.5 |
| | agent *16 | | | | |
| | Plasticizer: | 7.1 | 7.1 | 7.1 | 7.1 |
| | DINP | | | | |
| | Water | 0.3 | 0.3 | 0.3 | 0.3 |
| | absorbing | | | | |
| | agent *17 | | | | |
| Characteristics | Viscosity | 109000 | 23000 | 76000 | 147000 |
| | (30 C.°) | | | | |
| | TI value | 6.4 | 7.4 | 6.5 | 6.3 |

*11: polyoxypropylene polyol (number of functional groups: 3, Mw 4000, OH value 42, same in the following tables)
*12: DETDA (Baytec 505, produced by the BMS LLC Corporation, same in the following tables)
*13: A mixture of special grade heavy calcium carbonate produced by the Takehara Kagaku Kogyo Co., Ltd. and Nipsil LP manufactured by Nihon Silica Kogyo Co., Ltd. (same in the following tables)
*14: Nikkaoctix lead 17% DINP, produced by the Nihon Kagaku Sangyo Co., Ltd. (same in the following tables)
*15: A mixture of five types of hindered phenol and benzotriazole type stabilizer (produced by the API Corporation, Sumitomo Chemical Co., Ltd, Ciba Speciality Chemicals Corp. and Ouchi Shinko Chemical Industrial Co., Ltd., same in the following tables)
*16: ferric oxide (Bengara YO-400, produced by the Mikuni Color Co., Ltd., same in the following tables)
*17: VOP-T powder, produced by the Union Showa K. K. (same in the following tables)

TABLE 4

| B Component | | B-5 | B-6 | B-7 |
|---|---|---|---|---|
| Composition | Polyol 2 *11 | 21.2 | 21.2 | 21.2 |
| (parts) | Crosslinking agent *12 | 3.4 | 3.4 | 2.7 |
| | Filler *13 | 49.0 | 49.0 | 49.0 |
| | Catalyst *14 | 1.9 | 1.9 | 1.5 |
| | Inorganic thixotropic | 20.0 | 13.5 | 13.5 |
| | agent *2 | | | |
| | Organic thixotropic | — | 1.0 | — |
| | agent *3 | | | |
| | Weather stabilizer *15 | 1.1 | 1.1 | 1.1 |
| | Coloring agent: *16 | 2.5 | 2.5 | 2.5 |
| | Plasticizer: DINP | 7.1 | 7.1 | 7.1 |
| | Water absorbing | 0.3 | 0.3 | 0.3 |
| | agent *17 | | | |
| Charac- | Viscosity (30 C.°) | >200000 | >200000 | >105000 |
| teristics | TI value | — | — | — |

### Example 1

A-1 was used as the A component and B-1 was used as the B component and the mixing ratio (equivalent ratio of isocyanate and active hydrogen) was set to 1.25. The reactivity of the liquid mixture was such that the pot life was 12 seconds and the tack-free time was 50 seconds. The A and B components were sprayed in a mixed state at a discharge rate of 2.5 kg/m² using a two-liquid type spraying machine (Hydra Cat HP produced by Graco K.K.) onto the flat surface of a polyurethane base layer (JIS A-hardness 50) and cured to form a surface finishing layer, and the intended pavement was obtained. The surface layer of this surface finishing layer had a roughness with a peak-trough depth of 2.5 mm and the material was excellent as material for use as a pavement material for outdoor facilities. The physical properties of a pavement with this surface finishing layer were a displacement was 1.0 mm and an impact absorption rate of 35.2% and thus satisfied the IAAF specification. The elongation at break of a sheet obtained separately by mixing the A and B components together was 650% and satisfied the required value (500% or more).

Each of physical properties referred to in the above mentioned Example 1 was the value obtained with the method outlined below.

The peak-trough depth was measured at ten arbitrary positions of the surface of the surface finishing layer and the average value (mm) was calculated.

The vertical strain tester specified in the IAAF standard was arranged perpendicular to the pavement and a weight of 20 kg was dropped from a predetermined height and the displacement was measured in accordance with the IAAF standard test method.

The impact absorption tester specified in the IAAF standard was arranged perpendicular to the pavement and a weight of 20 kg was dropped from a predetermined height and the impact absorption value was measured in accordance with the IAAF standard test method.

The A and B components were mixed together, the mixture was molded using an aluminum mold of length 300 mm×width 150 mm×depth 2 mm of which the inner surface was coated with a fluorinated resin (no lubricant was used, normal temperature) and then cured at 23° C. for 7 days (or at 23° C. for one day+50° C. for one day) and sheets of thickness 2 mm were obtained. The elongation at break (%) of the sheets was measured in accordance with JIS K6251.

### Examples 2 to 8 and Comparative Examples 1 to 6

Pavements which had the intended surface finishing layers were obtained in the same way as in Example 1 described above using the combinations of the aforementioned eight types of A component and seven types of B component shown in Tables 5 to 8 below.

The physical properties etc. of the products of these examples and comparative examples were evaluated in the ways indicated below and the results are shown in Tables 5 to 8 below.

Pot life: The time (in seconds) elapsing after mixing the A and B components before the reaction mixture lost its fluidity.

Tack-free time: The time (in seconds) elapsing after mixing the A and B components before the tackiness when surface is touched with a finger disappeared.

The tackiness of the surface layer was evaluated as ◯ when the tack-free time was 150 seconds or less, and X when the tack-free time was more than 150 seconds.

The mixing state on discharging the A and B components in a mixed state using the two-liquid type spraying machine was observed visually and evaluated in two levels, namely Good: ◯; Poor: X.

In the same way as in Example 1, the peak-trough depth was measured at ten arbitrary positions on the surface of the surface finishing layer and the average value (mm) was calculated.

The roughness pattern on the surface of the surface finishing layer was observed visually and evaluated in two levels, namely Uniform with no deviation: ◯; Uneven with deviation: X.

TABLE 5

| | | | Example | | | |
|---|---|---|---|---|---|---|
| | | | 1 | 2 | 3 | 4 |
| Characteristics | A Component | | A-1 | A-2 | A-3 | A-6 |
| of surface | B Component | | B-1 | B-1 | B-1 | B-1 |
| finishing | Equivalent ratio of the A/B | | 1.25 | 1.25 | 1.25 | 1.25 |
| material | Components | | | | | |
| | Reactivity | Pot life | 12 | 14 | 7 | 12 |
| | (S) | Tack-free time | 50 | 59 | 30 | 50 |

| | | | | | |
|---|---|---|---|---|---|
| Evaluation | Tackiness of the surface | ◯ | ◯ | ◯ | ◯ |
| | Mixing properties of the two | ◯ | ◯ | ◯ | ◯ |
| | liquids | | | | |
| | Peak-trough depth of the | 2.5 | 2.3 | 3.0 | 2.0 |
| | roughness (mm) | | | | |
| | Roughness pattern | ◯ | ◯ | ◯ | ◯ |

TABLE 6

| | | | Example | | | |
|---|---|---|---|---|---|---|
| | | | 5 | 6 | 7 | 8 |
| Characteristics | A Component | | A-7 | A-8 | A-1 | A-1 |
| of surface | B Component | | B-1 | B-1 | B-3 | B-4 |
| finishing | Equivalent ratio of the A/B | | 1.25 | 1.25 | 1.25 | 1.25 |
| material | Components | | | | | |
| | Reactivity | Pot life | 12 | 12 | 11 | 13 |
| | (S) | Tack-free time | 50 | 52 | 47 | 55 |

| | | | | | |
|---|---|---|---|---|---|
| Evaluation | Tackiness of the surface | ◯ | ◯ | ◯ | ◯ |
| | Mixing properties of the two | ◯ | ◯ | ◯ | ◯ |
| | liquids | | | | |
| | peak-trough depth of the | 2.5 | 2.4 | 2.1 | 2.7 |
| | roughness (mm) | | | | |
| | Concave and convex pattern | ◯ | ◯ | ◯ | ◯ |

TABLE 7

| | | | Comparative example | | | |
|---|---|---|---|---|---|---|
| | | | 1 | 2 | 3 | 4 |
| Characteristics | A Component | | A-4 | A-5 | A-1 | A-1 |
| of surface | B Component | | B-1 | B-1 | B-2 | B-5 |
| finishing | Equivalent ratio of the A/B | | 1.25 | 1.25 | 1.25 | 1.25 |
| material | Components | | | | | |
| | Reactivity | Pot life | 7 | 12 | 11 | 13 |
| | (S) | Tack-free time | 28 | 50 | 46 | 56 |

| | | | | | |
|---|---|---|---|---|---|
| Evaluation | Tackiness of the surface | ◯ | ◯ | ◯ | ◯ |
| | Mixing properties of the two | X | ◯ | ◯ | X |
| | liquids | | | | |
| | Peak-trough depth of the | 3.0 | 0.5 | 1.0 | — |
| | roughness (mm) | | | | |
| | Concave and convex pattern | X | ◯ | ◯ | X |

TABLE 8

| | | | Comparative | |
|---|---|---|---|---|
| | | | example | |
| | | | 5 | 6 |
| Characteristics | A Component | | A-1 | A-1 |
| of surface | B Component | | B-6 | B-7 |
| finishing | Equivalent ratio of the A/B | | 1.25 | 1.25 |
| material | Components | | | |
| | Reactivity (S) | Pot life | 13 | 25 |
| | | Tack-free time | 55 | 170 |

| | | | |
|---|---|---|---|
| Evaluation | Tackiness of the surface | ◯ | X |
| | Mixing properties of the two liquids | X | ◯ |
| | Peak-trough depth of the roughness | — | 0.5 |
| | (mm) | | |
| | Concave and convex pattern | X | ◯ |

The following conclusions can be deduced from the above mentioned results.

### Effect of the NCO % of the A Component Polyisocyanate:

A good surface was obtained when the NCO % of the polyisocyanate in the A component was from 3.0 to 10.0% (Examples 2 and 3) but a uniform surface was not obtained when the NOC % was 12.0% (Comparative example 1). The viscosity of the A component rose as the NOC % fell and the usable A component viscosity range at 30° C. is thought to be from 1,000 to 10,000 mPa·s.

### Effect of a Thixotropic Agent in the A Component:

When the amount of organic thixotropic agent in the A component was from 0.1 to 2.6 parts (0.1 to 2.53%) the peak-trough depths of the roughness of the surface layer were all at least 2.0 mm (Examples 1, 4 and 5) but when no organic thixotropic agent was included the peak-trough depth of the roughness was only 0.5 mm (Comparative example 2). Furthermore, no increasing effect on the peak-trough depth of the roughness was seen when the organic thixotropic agent content was raised to 3.4 parts (3.29%) (Example 6).

### Effect of the Viscosity of the B Component:

A good surface layer was obtained when A-1 was used for the A component and the viscosity at 30° C. of the B component was from 76,000 to 147,000 mPa·s (Examples 1, 7 and 8) but when the viscosity at 30° C. of the B component was 23,000 mPa·s the peak-trough depth of the roughness was only 1.0 mm (Comparative example 3). Furthermore a uniform surface layer was not obtained when the viscosity at 30° C. of the B component exceeded 200,000 mPa·s (Comparative examples 4, 5).

### Effect of the Thixotropic Agent in the B Component:

The viscosity of the B component increased as the amount of an inorganic thixotropic agent used was increased (Examples 7, 1 and 8, and Comparative example 4). Hence the inorganic thixotropic agent is effective for achieving the viscosity required for a B component in the present invention. However, when an organic thixotropic agent was used together with an inorganic thixotropic agent in the B component the viscosity tended to exceed the upper limit for use (Comparative example 5). Hence the organic thixotropic agent is preferably used in the A component.

### Effect of the Reactivity:

A surface finishing layer was obtained by spraying a mixture of which the pot life was 25 seconds and the tack-free time was 170 seconds, but the peak-trough depth of the roughness was only 0.5 mm (Comparative example 6).

### Examples 9 to 12

A-1 was used for the A component and B-1 was used for the B component and the equivalent ratio of isocyanate and active hydrogen when mixing A-1 and B-1 was set to 0.8, 0.9, 1.3 or 1.5. Otherwise Examples 9 to 12 were the same as Example 1. From the results it was found that an equivalent ratio within in the range of 0.9 to 1.4 is appropriate. That is to say, when the equivalent ratio was less than 0.9 the reaction did not proceed satisfactorily and the physical properties such as the hardness of the surface finishing layer obtained were unsatisfactory. Furthermore, when the equivalent ratio exceeded 1.4 the elongation at break was reduced and the tack-free time became longer and tackiness was liable to remain after the surface finishing layer had been cured.

The present invention can be used ideally for the pavements of outdoor facilities such as all-weather athletics tracks, multipurpose playgrounds, park and recreation trails and the like.

1-15. (canceled)

16. A method for producing pavements for outdoor facilities in which a polyurethane surface layer which has a rough surface is formed, comprising forming a polyurethane surface finishing layer which has a surface roughness of peak-trough depth at least 2.0 mm by spraying
(1) component A, which comprises a composition comprising a urethane pre-polymer comprising terminal isocyanate groups, obtained by reacting MDI and a polyol, and which does not comprise elastic chips, and which has been prepared with a viscosity at 30° C. of from 1,000 to 10,000 mPa·s, as measured using a BH type No. 7 rotor at 20 rpm; and
(2) component B, which comprises a composition comprising a polyol, which comprises a crosslinking agent, a filler, a catalyst, and an inorganic thixotropic agent, and which does not comprise elastic chips, and which has been prepared with a viscosity at 30° C. of from 70,000 to 200,000 mPa·s, as measured using a BH type No. 7 rotor at 20 rpm;
in a mixed state onto a polyurethane base-layer of JIS A-hardness from 40 to 65 and which has a flat surface, wherein each component A and B is metered separately.

17. The method of claim 16, wherein components A and B have a reactivity such that the pot life of the mixed liquid obtained on mixing the two liquids is from 5 to 20 seconds and the tack-free time is not more than 150 seconds.

18. The method of claim 16, wherein the urethane pre-polymer of component A is a pre-polymer which has terminal isocyanate groups, obtained by reacting diphenylmethane di-isocyanate with a polyether polyol which has an average number of functional hydroxyl groups of from 2 to 4 and an average molecular weight of from 2,000 to 8,000 and wherein the polyoxyethylene chain content of the polyether chain is not more than 30 weight %, and wherein the NCO content is within the range of from 3 to 10 weight %.

19. The method of claim 18, wherein the polyol of component B is a polyether polyol which has an average number of functional hydroxyl groups of from 2 to 4, an OH value of from 20 to 100 mg KOH/g, and an average molecular weight of from 2,000 to 8,000, and wherein the polyoxyethylene chain content of the polyether chain is not more than 30 weight %.

20. The method of claim 16, wherein the crosslinking agent is an aromatic amine based crosslinking agent.

21. The method of claim 20, wherein the polyurethane base-layer is a layer obtained by reacting diphenylmethane di-isocyanate and polyol.

22. The method of claim 16, wherein component A comprises from 0.1 to 2.6 weight % of organic thixotropic agent.

23. A surface finishing material comprising:
(1) component A, which comprises a composition comprising a urethane pre-polymer comprising terminal isocyanate groups, obtained by reacting MDI and a polyol, and which does not comprise elastic chips, and which has been prepared with a viscosity at 30° C. of from 1,000 to 10,000 mPa·s, as measured using a BH type No. 7 rotor at 20 rpm; and
(2) component B, which comprises a composition comprising a polyol, which comprises a crosslinking agent, a filler, a catalyst, and an inorganic thixotropic agent, and which does not comprise elastic chips, and which has been prepared with a viscosity at 30° C. of from 70,000 to 200,000 mPa·s, as measured using a BH type No. 7 rotor at 20 rpm.

24. The surface finishing material of claim 23, wherein components A and B have reactivities such that the pot life of the mixed liquid obtained on mixing the two liquids is from 5 to 20 seconds and the tack-free time is not more than 150 seconds.

25. The surface finishing material of claim 23, wherein the urethane pre-polymer of component A is a pre-polymer which has terminal isocyanate groups, obtained by reacting diphenylmethane di-isocyanate with a polyether polyol which has an average number of functional hydroxyl groups of from 2 to 4, an average molecular weight of from 2,000 to 8,000, wherein the polyoxyethylene chain content of the polyether chain is not more than 30 weight %, and wherein the NCO content is within the range of from 3 to 10 weight %.

26. The surface finishing material of claim 23, wherein the polyol of component B is a polyether polyol which has an average number of functional hydroxyl groups of from 2 to 4, an OH value of from 20 to 100 mg KOH/g, an average molecular weight of from 2,000 to 8,000, and wherein the polyoxyethylene chain content of the polyether chain is not more than 30 weight %.

27. The surface finishing material of claim 23, wherein the crosslinking agent is an aromatic amine based crosslinking agent.

28. The surface finishing material of claim 23, wherein component A contains from 0.1 to 2.6 weight % of an organic thixotropic agent.

29. A pavement for outdoor facilities obtained by the method of claim 16, wherein a polyurethane surface finishing layer having an elongation at break of at least 500% and which has a surface roughness of peak-trough depth at least 2.0 mm and does not contain elastic chips has been formed on a base-layer comprising cured polyurethane of JIS A-hardness from 40 to 65 and which has a flat surface.

30. The pavement for outdoor facilities of claim 29, wherein the pavement has a displacement of from 0.6 to 2.2 mm and an impact absorption rate of from 34 to 51%.
